(19) United States
(12) Patent Application Publication
(10) Pub. No.: US 2017/0177170 A1
(43) Pub. Date: Jun. 22, 2017

(54) PROGRESS CONTROL BASED ON TRANSFER OF LAYERED CONTENT

(71) Applicant: International Business Machines Corporation, Armonk, NY (US)

(72) Inventors: Zhen Hong Ding, Shanghai (CN); Fang Liang Dong, Shanghai (CN); Chang Lei, Shanghai (CN); Xiao Xia Mao, Shanghai (CN); Wenwen Yang, Shanghai (CN); Wei Jun Zheng, Shanghai (CN); Jie Zhu, Shanghai (CN)

(21) Appl. No.: 14/972,731

(22) Filed: Dec. 17, 2015

(51) Int. Cl. G06F 3/0482; G06F 3/0481; G06F 3/0488; G06F 3/0485

(52) U.S. Cl. CPC G06F 3/0482; G06F 3/0485; G06F 3/04817; G06F 3/04883

(57) ABSTRACT

Progress bar for visually indicating information about a corresponding ordered (for example), time ordered list of items (for example, clickable items representing social media posts). Some embodiments of the progress bar may include one, or more, of the following features: (i) different “interest/interaction statuses” corresponding to the list items; (ii) user interaction zones for jumping the displayed list of items to newly-created items and jumping back to a location in the list where the user was before jumping to the newly-created list items; and/or (iii) adjustable “density” progress bar icons that dynamically vary the number of list items corresponding to a single icon depending up the number of list items loaded to a mobile device.

### BACKGROUND OF THE INVENTION

The present invention relates generally to the field of a “progress bar” component of a visual user interface, and more particularly to a progress bar suitable for mobile devices with touchscreen displays.

A progress bar is typically defined as a graphical control element that is used to visualize the progress of a computer operation. These operations typically include items such as a file download, file transfer, or program installation. Progress bars typically use a linear function, where the operation is directly proportional to how much of the task being worked has been completed. In some instances progress bars can exhibit non-linear behavior due to factors such as the amount of computer memory space available, processor speed, and other factors. Some conventional program progress bars include a control mechanism based on the position of a “slider” relative to a visually displayed “progress bar.”

In many applications (or apps), such as social media apps, a long “list” of “items” is displayed to the user. Each “item” is an abbreviated version of a longer, or larger, piece of content that can be displayed more fully when a user selects the item in the list (for example, by tapping the item as it is displayed in the list on a touchscreen display of a mobile smart phone). Sometimes the abbreviation, which is displayed as the item in the list, is a truncated version of a larger piece of text. Sometimes the abbreviation is a “thumbnail” version of an image that is better viewed at a larger size. Other types of abbreviations are also possible.

As mentioned above, lists of items are typically long—too long for all items to be displayed at once on a display (for example, the touchscreen display of a typical mobile phone). Also, different items tend to have different interest levels for a user. Sometimes a user is not interested in the item at all. Sometimes a user is interested enough to review the abbreviation, but not interested enough to select the list item to view the full associated content. Sometimes a user will be so interested in an item that she selects the item to view the full content. Sometimes the user is so interested in the item that the user does both of the following: (i) selects the item for full viewing; and (ii) flags the item for repeat viewing at a later time. A user's interest level in an item may be, at least loosely, correlated with time, such as where a user is more interested in newly received items than in items that were received substantially earlier than a current time and date.

Typically, in order to scan a list of new and old items, a user scrolls (for example, vertically scrolls) the list of items which are arranged in some order (typically, the list is in an order from most recently received to oldest). In this document, the beginning of a list will be referred to as the “top” of the list, even if the display is not a vertically scrolling display. Similarly, the “up” direction of scrolling will be a direction towards the beginning of the list, and the “down” direction will be the direction toward the end of the list.

The position of the currently displayed items on a list, with respect to their position within the full list, is sometimes conventionally represented by a progress bar that is displayed along with the items of the currently displayed portion of the list. The progress bar changes its visual indication as the user scrolls the currently displayed items “up” and “down” with respect to the full list.

### SUMMARY

According to an aspect of the present invention, there is a method, computer program product and/or system that performs the following operations (not necessarily in the following order): (i) defining a plurality of interest/interaction statuses; (ii) receiving input data corresponding to a plurality of list items of an ordered list; (iii) classifying, by machine logic, each of the plurality of list items so that each list item of the plurality of list items corresponds to at least one status of the plurality of interest/interaction statuses; (iv) generating, by machine logic, first display data corresponding to a first display including a list item display portion displaying, in list order, at least a portion of the list items of the plurality of list items; and (v) generating, by machine logic, first display data corresponding to a first display including a progress bar display portion displaying a progress bar, with the progress bar providing a visual indication of the relative number of list items correspond to each status of the plurality of interest/interaction statuses.

According to an aspect of the present invention, there is a method, computer program product and/or system that performs the following operations (not necessarily in the following order): (i) generating, by machine logic, first display data corresponding to a first display including a list item display portion displaying, in list order, at least a portion of list items of an ordered plurality of list items including viewed list items and unviewed list items; (ii) generating, by machine logic, first display data corresponding to a first display including a progress bar display portion displaying a progress bar, with the progress bar providing a visual indication of the amounts viewed list items and unviewed list items and including a first user interaction portion and a second user interaction portion; (iii) subsequent to generation of the first display data and responsive to a first user gesture on, or in, the first user interaction portion, generating second display corresponding to a second display, including a list item display portion displaying, in list order, only unviewed list items of the ordered plurality of list items; and (iv) subsequent to generation of the second display data and responsive to a second user gesture on, or in, the second user interaction portion, creating third display corresponding to a third display, including a list item display portion including, in list order, list items displayed at a time the first user gesture was made.

According to an aspect of the present invention, there is a method, computer program product and/or system that performs the following operations (not necessarily in the following order): (i) receiving input data corresponding to a plurality of list items of an ordered list; (ii) generating, by machine logic, first display data corresponding to a first display including a list item display portion displaying, in list order, at least a portion of the list items of the plurality of list items; (iii) generating, by machine logic, first display data corresponding to a first display including a progress bar display portion displaying a progress bar, with the progress bar including icons, with each icon representing a set of n list items with n being an integer; and (iv) dynamically determining during a user list item interaction session, by machine logic, a value for n based, at least in part, upon a number of list items that have been loaded to a mobile device including display hardware for displaying the first display.

### BRIEF DESCRIPTION OF THE DRAWINGS

FIG. 1 depicts a cloud computing node used in a first embodiment of a system according to the present invention;

FIG. 2 depicts an embodiment of a cloud computing environment (also called the “first embodiment system”) according to the present invention;

FIG. 3 depicts abstraction model layers used in the first embodiment system;

FIG. 4 is a flowchart showing a first embodiment method performed, at least in part, by the first embodiment system;

FIG. 5 is a first screenshot showing at least a portion of a display generated by machine logic of the first embodiment system;

FIG. 6 is a second screenshot showing at least a portion of a display generated by machine logic of the first embodiment system;

FIG. 7 is a third screenshot showing at least a portion of a display generated by machine logic of the first embodiment system;

FIG. 8 is a fourth screenshot showing at least a portion of a display generated by machine logic of the first embodiment system;

FIG. 9 is a fifth screenshot showing at least a portion of a display generated by machine logic of the first embodiment system;

FIG. 10 is a sixth screenshot showing at least a portion of a display generated by machine logic of the first embodiment system;

FIG. 11 is a seventh screenshot showing at least a portion of a display generated by machine logic of the first embodiment system;

FIG. 12 is an eighth screenshot showing at least a portion of a display generated by machine logic of the first embodiment system;

FIG. 13 is a ninth screenshot showing at least a portion of a display generated by machine logic of the first embodiment system;

FIG. 14 is a tenth screenshot showing at least a portion of a display generated by machine logic of the first embodiment system;

FIG. 15 is a eleventh screenshot showing at least a portion of a display generated by machine logic of the first embodiment system;

FIG. 16 is a twelfth screenshot showing at least a portion of a display generated by machine logic of the first embodiment system; and

FIG. 17 depicts a progress bar in the form of a sandglass.

### DETAILED DESCRIPTION

Some embodiments of this UI interaction method, and associated display, can: (i) dynamically, and bi-directionally, receive contents (such as new updates and history records); (ii) indicate contents with different statuses (for example, old-unreviewed, new-unreviewed, reviewed, and fully) using differentiating visual indicators; (iii) reflect the transfer process of the content status, along with a user's behavior, in real-time using visual indicators; (iv) unconsciously track and/or bookmark a user's reading process; (v) responsive to a user's selection of a selected indicator, display the contents represented by the selected indicator on a display; and/or (vi) allow a user to conveniently provide user input to switch between contents with one status and contents with another status.

Some embodiments include a progress bar for visually indicating information about a corresponding ordered (for example, time ordered) list of items (for example, clickable items representing social media posts). Some embodiments of the progress bar may include one, or more, of the following features: (i) different “interest/interaction statuses” corresponding to the list items; (ii) user interaction zones for jumping the displayed list of items to newly-created items and jumping back to a location in the list where the user was before jumping to the newly-created list items; and/or (iii) adjustable “density” progress bar icons that dynamically vary the number of list items corresponding to a single icon depending upon the number of list items loaded to a mobile device.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

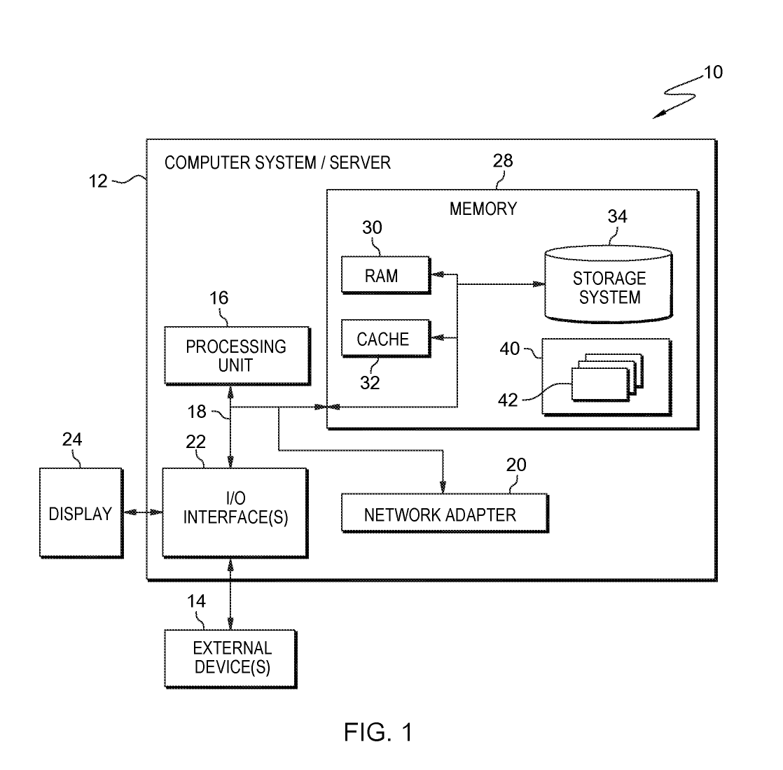

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

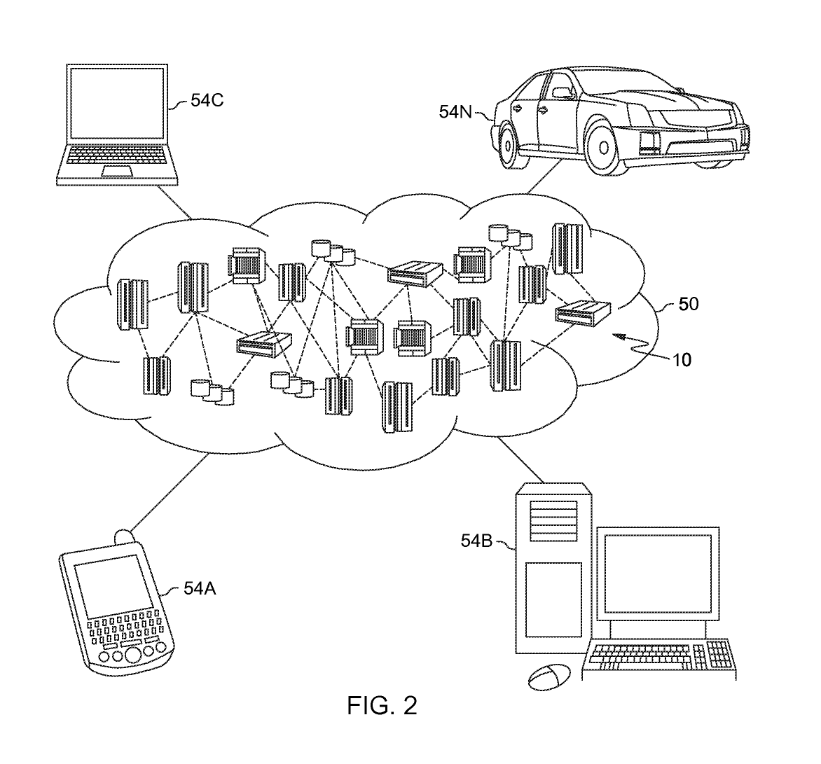

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

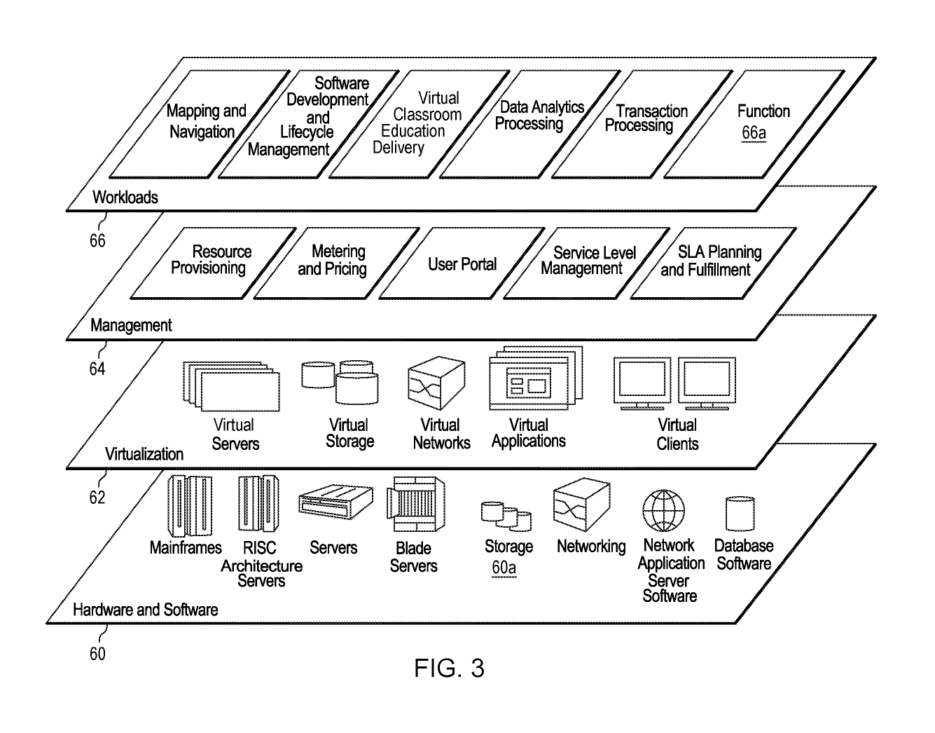

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes; RISC (Reduced Instruction Set Computer) architecture based servers; storage devices; networks and networking components. In some embodiments software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and functionality according to the present invention (see function block 66a) as will be discussed in detail, below, in the following sub-sections of this Detailed description section.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

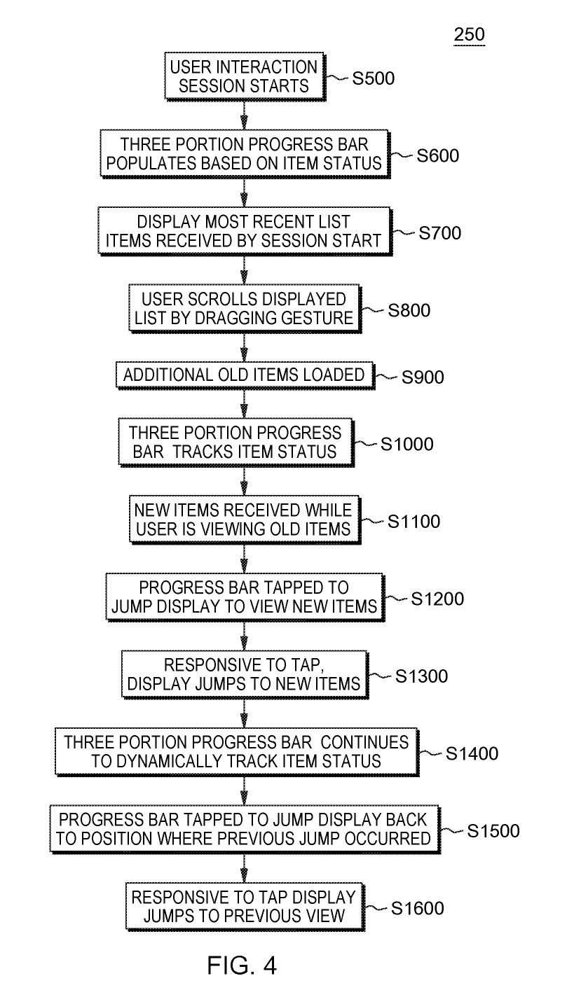

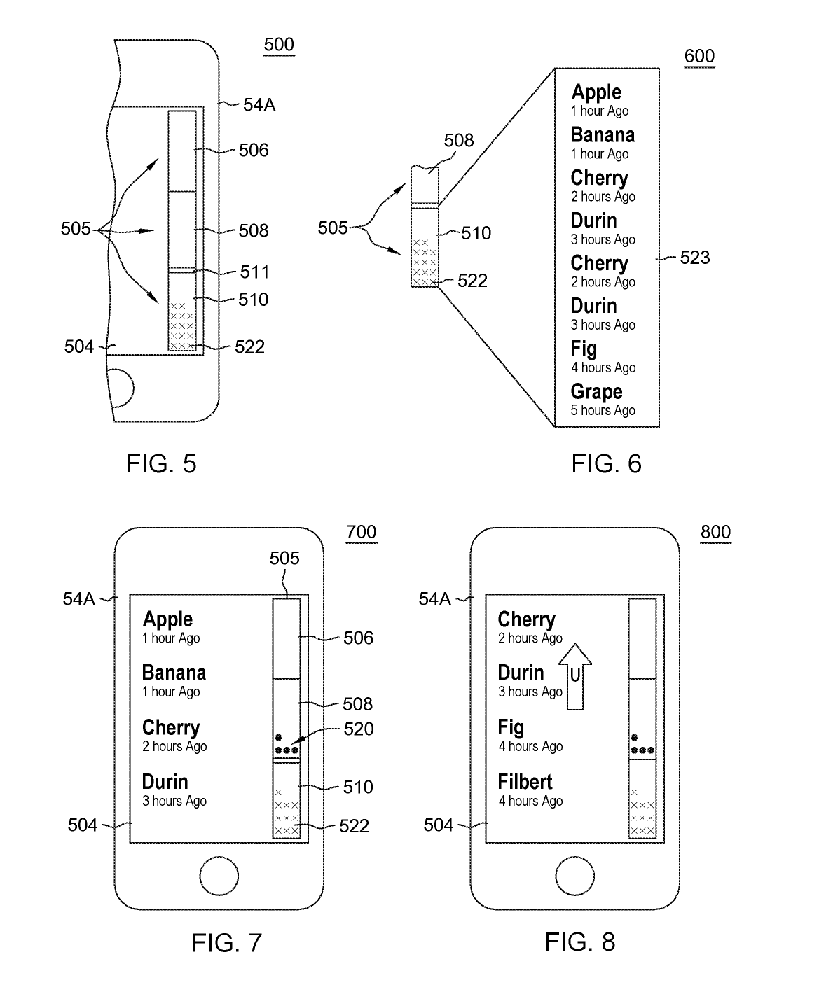

Before discussing FIGS. 4 and 5, the concept of “interest/interaction status”(see definition, below) will be discussed. Some embodiments of the present invention classify list items according to a pre-defined set of statuses based on expected levels of user interaction and/or interest. Some possible types of status categories are: (i) old unread, that is, list item received in the past and never selected for viewing of full content; (ii) new unread, that is, list item received relatively recently and never selected for viewing of full content; (iii) read, that is, user has selected list item to be presented with its content (for example, text content, graphic content, audio content); (iv) unread; (v) viewed, that is, list item has been displayed to user on the display for at least some threshold amount of time; (vi) unviewed, that is, list item has been displayed to user on the display for at least some threshold amount of time; (vii) scrolled through (regardless of how fast the item has been scrolled through); (vii) not scrolled through; and/or (ix) various combinations of the foregoing types of status categories. The following paragraphs will discuss how this breakdown of list items according to interest/interaction category is used in some embodiments of the present disclosure. Some embodiments provide a visual indication of the status transfer of contents, which is to say that a user receives a visual indication when a list items (or some threshold number of list items) is subject to a status change from a first interest/interaction status to a second interest/interaction status. Note that “interest/interaction status” will sometimes be more simply referred to herein as “status.”

FIG. 4 shows flowchart 250 depicting a method according to the present invention. FIGS. 5 to 16 show screenshots, taken at various times 500 to 1600 corresponding to the display presented by the user as the operations of flowchart 250 are performed over time. This method and associated screen displays will now be discussed, over the course of the following paragraphs, with extensive reference to FIG. 4 (for the method step blocks) and FIG. 5 to 16 (for the corresponding screen displays). The screen displays are generated by corresponding portions (for example, “modules”) of machine logic (not separately shown) stored in storage block 60a (see FIG. 3) and/or memory 28 (see FIG. 1) built into device 54A (see FIG. 2).

FIGS. 5 to 16 respectively show mobile device 54A at various times (represented by reference numerals 500, 600, 700, 800, 900, 1000, 1100, 1200, 1300, 1400, 1500, 1600) during user interaction session, where the user interacts with a list of items. In this embodiment, there are three mutually exclusive interest/interactions statuses, meaning that each list item corresponds, at any given time, to one of the following three status categories: (i) first status (new-unviewed): newly-received and not yet displayed (that is not yet displayed for at least a threshold amount of time t); (ii) second status (viewed): displayed during the current user interaction session for at least a threshold amount of time t; or (iii) third status (old-unviewed): received prior to the beginning of the user interaction session but not yet displayed during the current user interaction session (for at least a threshold amount of time t). In this embodiment, when a user interaction session starts, fourteen (14) list items are loaded, and, initially, these items will all correspond to the third status. As will be seen in the discussion of FIGS. 5 to 16, below, during a user interaction session: (i) the status of an item may change from the first status to the second status (when a newly-received item has been displayed for the threshold amount of time t); and (ii) the status of an item may change from third status to second status (when an older item has been displayed for the threshold amount of time t). The three interest/interaction status categories set forth in this paragraph are only one possibility for a set of interest/interaction status categories for classifying list items that be used in connection with various embodiments of the present invention.

As shown in FIG. 5 (see operation S500 in FIG. 4), mobile device 54A includes touchscreen screen 504, three portion progress bar 505; first progress bar portion 506; second progress bar portion 508; third progress bar portion 510; double bar 511; and third status list item icons 522 (represented as X's). At time 500, a new user session has just been started, so fourteen previously existing list items have been loaded to mobile device 54A, and all of these items have the third status (old-unviewed). In this embodiment, these fourteen (14) old-unviewed list items: (i) are each respectively represented by an X icon 522 in third portion 510 of progress bar 505; and (ii) represent the fourteen (14) most recently received list items, regardless of whether the user has viewed some, or all, of these items in a previous list item interaction session.

As shown in FIG. 6 (see operation S600 in FIG. 4), at time 600 (which is very close to time 500), the fourteen loaded items are still considered to be unviewed. Block 523 shows the top eight (8) items of the list of fourteen (14) loaded items to demonstrate that: (i) the items are ordered from most recent to least recent; and (ii) the entire list of fourteen (14) loaded items would be too large to fit on display 504 all at once.

As shown in FIG. 7 (see operation S700 in FIG. 4), at time 700 (at time interval t after time 500), the top four (that is, most recent four) loaded list items (specifically Apple, Banana, Cherry, Durin) have been displayed on display 504 for time interval t. In this example, only four items fit on display 504 at once, which is why only four of the fourteen loaded items have been displayed for time interval t. Because these four items have been displayed for time interval t: (i) the interest/interaction status for these four list items is changed from old-unviewed (third status) to viewed (second status); (ii) four filled circle icons 520 have been added to second progress bar portion 508, with these four filled circle icons representing the four viewed messages; and (iii) four X icons 522 have been removed from third progress bar portion 510 to reflect the fact that there are only ten (10) old-unviewed messages left at time 700. First progress bar portion 506 is still empty of icons because there are no new-unviewed messages (that is, messages received since the start of the first user interaction session.

As shown in FIG. 8 (see operation S800 in FIG. 4), at time 800, the user makes an upward direction gesture as indicated by arrow U. Accordingly: (i) the list items Apple and Banana have scrolled up off of the display shown on display 504; (ii) list items Cherry and Durin are shown as moving upwards; and (iii) older old-unviewed status list items Fig and Filbert have moved up into the display area of display 504.

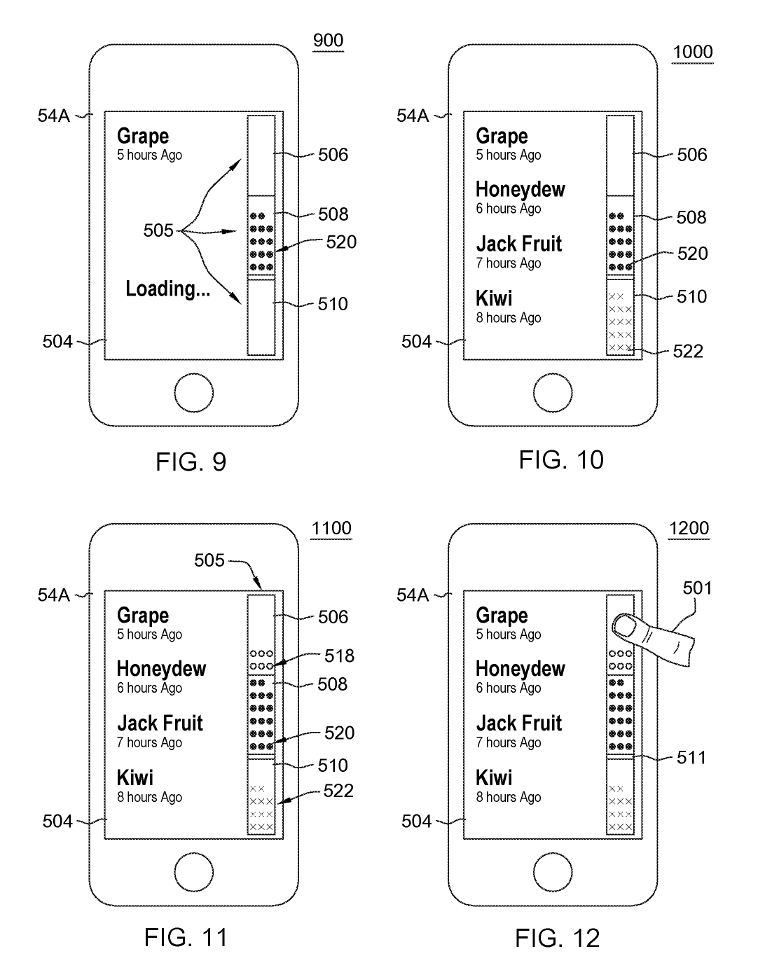

As shown in FIG. 9 (see operation 5900 in FIG. 4), at time 900, the user has finished her upward gesture and scrolled the list of displayed items as far as it will go, so that the oldest of the fourteen initially-loaded list items (specifically Grape) appears at the top of the display presented on display 504. At this point in time, all fourteen initially-loaded list items (Apple to Grape) have been displayed for at least time interval t, so fourteen (14) filled circle icons 520 appear in second progress bar portion 508 to indicate that fourteen list items have the second status (that is, viewed status). First progress bar portion 506 of progress bar 505 has no icons in it because there are still no new-unviewed list items at time 900. Third progress bar portion 510 of progress bar 505 has no icons in it because all of the loaded list items have been viewed as of time 900. As indicated on display 504, at time 900, mobile device 54A is loading older list items over a wireless communication network.

As shown in FIG. 10 (see operation 51000 in FIG. 4), at time 1000, fourteen (14) of the older list items have just finished loading, and have the interest/interaction status of old-unviewed, as indicated by the fourteen (14) X icons 522 in third progress bar portion 510. Of the newly-loaded, but received in the past, items, the most recent three (3) (that is, Honeydew, Jack Fruit and Kiwi) are visible in display 504 (but have not yet been displayed for a time interval t). There are still fourteen (14) other list items that have the second status (that is, viewed). There are still no list items that have the first status (that is, new-unviewed).

As shown in FIG. 11 (see operation S1100 in FIG. 4), at time 1100 (which is time interval t later than time 1000), the list items Honeydew, Jack Fruit and Kiwi have now been displayed for a sufficiently long time so that the status of these list items changes from third status (that is, old-unviewed) to second status (that is, viewed). Accordingly, at time 1100: (i) third progress bar portion 510 now has only eleven (11) X icons 522; and (ii) second progress bar portion 508 now has seventeen (17) filled circle icons 520. Also, by time 1100, six (6) new list items, received at a server subsequent to the start of the current user interaction session, have been received at mobile device 54A over the wireless communication network. These six list items have status new-unviewed because they have not yet been displayed in the display of display 504. However, the user can surmise that the six (6) new new-unviewed items are present because there are now six (6) unfilled circle icons 518 in first progress bar portion 506 of progress bar 505.

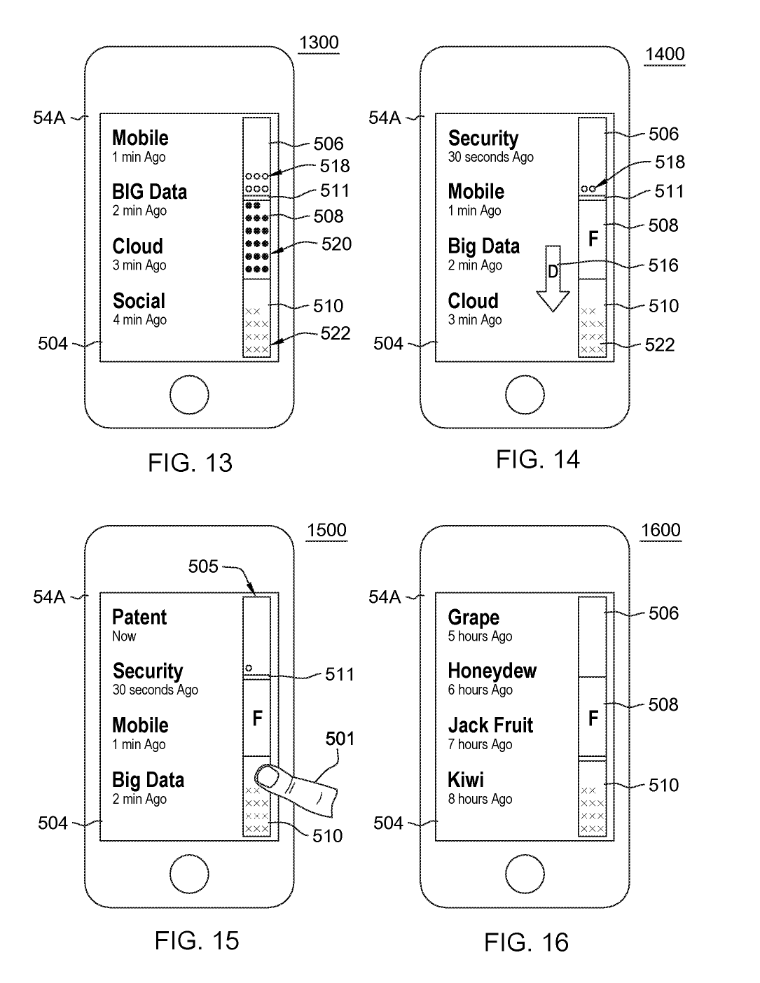

As shown in FIG. 12 (see operation S1200 in FIG. 4), at time 1200, the user 501 is about to tap first progress bar portion 506 in order to view some of the new-unviewed items. At this time, double line 511 visually indicates that the user is down in a portion of the list of items where the items have been viewed. However, after user 501 taps the first progress bar portion 508, at time 1300 (as shown in FIG. 13, see, also, operation S1300 in FIG. 4)): (i) the display shows the oldest four (4) list items (specifically, Mobile, Big Data, Cloud, Social) of the six (6) new-unviewed list items received back at time 1100. In this way, by a simple gesture on the new-unviewed status portion of the progress bar, the user can view new-unviewed status list items, near the top of the list, quickly and without the effort of scrolling through the list.

Because new-unviewed items are now being viewed, at time 1300, double bar 511 has moved from the location shown in FIG. 12 to the location shown in FIG. 13. This visually indicates to the user that she is now viewing list items near the top of the list. Alternatively, other types of visual indications can be used to show this, such as moving the icons of the second status bar portion from a bottom lobe of a sandglass style progress bar to the top lobe of a sandglass style progress bar.

As shown in FIG. 14 (see operation S1400 in FIG. 4), at time 1400 (occurring at time interval t later than time 1300), the user has made a downward swipe gesture on touchscreen display 504, as indicated by arrow D. This causes the display to vertically scroll to the top of the list and show the most recent four (4) items (specifically, security, Mobile, Big Data and Cloud). By time 1400, the list items Mobile, Big data, Cloud and Social have been displayed for sufficiently long that their status changes from first status (that is, new-unviewed) to second status (that is, viewed). As a consequence of this status change: (i) there are only two remaining unfilled circle icons 518 remaining in first progress bar portion 506 corresponding to remaining new-unviewed status items Security and Mobile; (ii) there are now twenty-one (21) list items having a viewed status; and (iii) because second progress bar portion 508 can only fit eighteen (18) icons, it now displays an “F” designation (indicating full).

As shown in FIG. 15 (see operation S1500 in FIG. 4), at time 1500, while the user is viewing the most recent items (including the newest list item, Patent (having a new-unviewed status), as visually indicated by the position of double bar 511 between first progress bar portion 506 and second progress bar portion 508.

At time 1500, user 501 desires to go back to viewing older list items, and, more specifically, the older list items that the user was viewing at 1200, just before she tapped the first progress bar portion to quickly move the display up to the new-unviewed items. This is believed to be a typical desire for users, who often take breaks from viewing and reading older list items in order to check out list items that have come in recently. When the reading of the new list items is finished, the user typically wants to go back to the same position in the list that she was viewing before the new item break. Conventionally this is done by vertically scrolling down the list of items until the user again sees the items that she was viewing before her new item break. However, some embodiments of the present invention recognize: (i) this vertical scrolling can be time and effort intensive (especially if the list of items is long); and (ii) it places a mental tax on the user to remember where she was before the new item break. In this embodiment, instead of vertically scrolling back down to where user 501 was at previous time 1200, at time 1500 user 501 is preparing to tap first progress bar portion 510. By performing this tap gesture, and as shown in FIG. 16 (showing time 1600, which is soon after time 1500 and after the tap gesture has been completed), display 504 shows the list items that user 501 was viewing at previous time 1200.

As further shown in FIG. 16 (see operation S1600 in FIG. 4), double bar 511 moves again in response to the tapping gesture in order to indicate that the display is now showing relatively old (that is, viewed status and/or old unviewed status list items).

As further shown in FIG. 16, as user 501 was preparing to tap first progress bar portion, time interval t passed, such that new-unviewed item Patent was changed in its interest/interaction status to viewed status. This is why, in FIG. 16, there are no remaining unfilled circle icons in first progress bar portion 506.

### III. Further Comments and/or Embodiments

Some progress bar embodiments of the present invention may include one, or more, of the following features, characteristics and/or advantages: (i) dynamic completion status display, with interaction involved; (ii) can be dynamically updated; (iii) can switch between layers; (iv) based on content status in addition, and/or as an alternative to, time sequence of list items; (v) suitable for the mobile end because there might be many colored layers; and/or (vi) suitable for dynamically updated applications because there is loading without a “jumping slider.”

Some embodiments of the present invention may include one, or more, of the following features, characteristics and/or advantages: (i) provide a new UI (user interface) interaction method for progress control; (ii) layer contents with different statuses; (iii) helps a user visualize the transfer of contents through the use of variant velocity; and/or (iv) provides more friendly and consistent user experiences for bi-directionally and dynamically updated mobile applications, which can load contents from both the top (real-time received contents) and the bottom (history records).

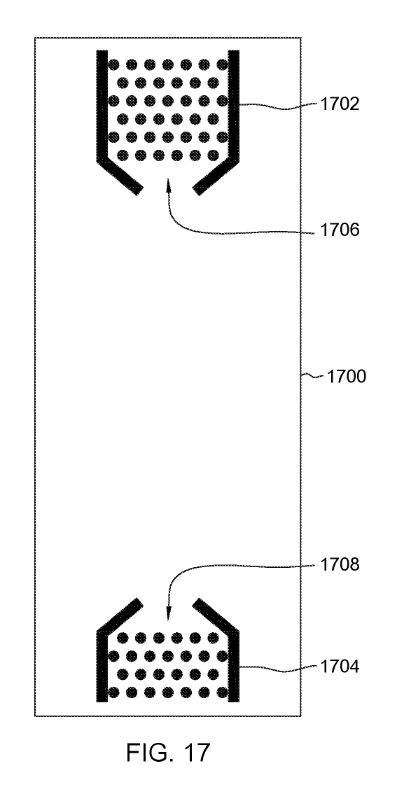

Some embodiments of the present invention include a progress bar in the form of a sandglass. Progress bar 1700, shown in FIG. 17 (including upper lobe 1702, lower lobe 1704, upper lobe icons (or sand grains) 1706, and lower lobe icons (or sand grains) 1708) shows an example of a sandglass style progress bar. As those of skill in the art will appreciate, the items in a list are visually rendered for the user in a progress bar display like sand in the glass. These grains flow from one sandglass lobe display to the other sandglass lobe display as a user views, or reads, the list items, in order to help the user visualize the transfer process of content status. In some embodiments of the present disclosure list items having different “interest/interaction statuses” are visually differentiated (that is, “layered”). For example, in some embodiments, list items having different “interest/interaction statuses”(see definition, below) are respectively represented by sand grains of different colors. In this way, users can be alerted when new contents come. In some embodiments, and as will be further explained, below, users can also easily switch between the newly received updates (that is, at, or near, the top of the list) and where the use was (before jumping to the top of the list to see new messages).

In some sandglass style progress bar embodiments: (i) the direction of the sand flow is the same as the direction of the flow of list items, which may provide an intuitive user experience; (ii) the scrolling speed is visualized by the transfer speed of the sand flow; (iii) when new contents are loaded, the sand in the glass grows more; and/or (iv) the number of list items represented by one grain of sand can be further customized to accommodate typical list item volumes and avoid situations where lobes of the sandglass are “overfilled” with sand grains.

Implementation of static state will now be discussed. The vertical progress control for a window showing a list of items is used as an example. With a fixed window width (effectively fixed by the width of the display screen), the length required to show the entire lit of list items is represented by the length of contents variable L_{c}. In the some embodiments of the present disclosure, the length of static contents (L_{c}) is mapped to the size of a pile of sand (Sₚ). For simplicity, a proportionality coefficient variable a is designated to represent their relationship. Assume a pile of sand is composed of n grains of sand that have the same size (S_{g}). This means that:

$$\{ \begin{matrix}{L}_{c} = α ⋆ {S}_{p} \\ {S}_{p} = n ⋆ {S}_{g}\end{matrix}$$

In conclusion, the amount of static content within this window can be represented by the size of n grains of sand:

L_{c}=α*S_{g}*n

Implementation of the transfer state will now be discussed. The implicit change of the “interest/interaction status” of various list items (for example, from “old-unviewed” to “viewed”) is, in some embodiments, visualized represented by one or more of the following visual features: (i) movement of icons (for example, sand grains), representing list items undergoing a status change, within the progress bar display; (ii) change of color of icons representing list items undergoing a status change; (iii) changes in a display of human readable numbers respectively representing items having different statuses; and/or (iv) change in icon shape and/or typography (for example, bold, underlined) of icons representing list items undergoing a status change.

Assume the initial start line of contents is at h pixel height within the current window, which is deemed as the boundary between the old-unviewed and viewed contents. A user starts a dragging gesture to vertically scroll the display of list items. In some embodiments, at this moment, the flow line of sand grains appears, and these sand grains start moving along with the scrolling of the list to reflect status changes of list items from “old-unviewed” to “viewed” as corresponding list items scroll through the display and are (presumably) viewed by the user.

With the mathematics method of infinitesimal analysis, use Δt to represent a very short period of time. During Δt, the user drags the content above/below the h pixel for a distance of ΔL_{c}, and his dragging speed is V_{d}. Then during Δt, the transferred number of sand (Δn) will be mathematically represented as follows:

$$Δ n = \frac{Δ {L}_{c}}{α ⋆ {S}_{g}} = \frac{Δ t ⋆ {V}_{d}}{α ⋆ {S}_{g}}$$

During Δt, use v to represent the speed of sand transfer, which is actually the number of transferred sand grains per second:

$$υ = \frac{Δ n}{Δ t} = \frac{{V}_{d}}{α ⋆ {S}_{g}}$$

In conclusion, the transfer of sand grains is a motion with variable velocity, and its instantaneous velocity is determined by the instantaneous velocity of the user's dragging behavior (V_{d}), and preset parameters (α and Sg). Thus in such a sand transfer motion with variable velocity, the transferred number of sand grains n during a time period t1 to t2 will be (use L_{c} to represent the dragged content distant during t₁ to t₂):

$$n = {\int }_{{t}_{1}}^{{t}_{2}} Δ n = \frac{1}{α ⋆ {S}_{g}} ⋆ {\int }_{{t}_{1}}^{{t}_{2}} Δ {L}_{c} = \frac{{L}_{c}}{α ⋆ {S}_{g}}$$

To state the foregoing example in more simple and general terms. Some embodiments of the present invention use the visual display of the progress bar to show how many list items are being scrolled through as the user is scrolling through list items. This can be helpful because during vertical scrolling, the items may go by so fast that the user cannot meaningfully count, or even estimate, how many list items she has scrolled through. In some embodiments, the visual indication of scrolling through items may take the form of moving icons from one portion of the progress bar to another (for example, from one lobe of a sandglass to the other). Alternatively, other human understandable visual display features may be used to represent the relative split between: (i) the number of list items above the user's presently displayed position in the list of items; and (ii) the number of list items below the user's presently displayed position in the list of items.

In some embodiments, “interest/interaction status” may depend upon whether an item has been scrolled through, regardless of how quickly the user has scrolled through the item. For example, in some embodiments that use “viewed” and “old-unviewed” as two of the interest/interaction statuses, a list item may be changed to “viewed” status, even if it is scrolled through very quickly. On the other hand, in the embodiment of FIGS. 5 to 16, discussed in detail, above, scrolling through an item does not change its interest/interaction status. In that embodiment, the location of double bar 511 gives the user only a rough idea of the relative currently displayed position within the list of items. In still other embodiments, the progress bar may be designed to depict neither scrolling speed, nor relative position in the list of items.

Other implementation details will now be discussed. α is a preset parameter that can be flexibly chosen to fit the window size and the sandglass size. α can be further optimized to accommodate a user's reading habit. Because new sand can be loaded from two directions into the sandglass, thus when the sandglass is full, there'll be an automatic compression to adapt the sand size to fit the current contents. To reduce the times that the compression behaviors happen to the user, the α parameter can be customized as follows: (i) use L_{c}′ to represent the amount of contents that the user is most likely to read for one time, which can include multiple pages of history records. L_{c}′ can be got by using the existing user behavior learning and data mining technologies; and (ii) use L_{c}′ to map to the maximum sand size (S_{pf}) to determine the α parameter:

$$α = \frac{{L}_{c}^{′}}{{S}_{pf}}$$

The faster the user drags the content, the faster the sand grains transfer from one lobe of the sandglass to the other. This can be visualized by larger density of sandgrains appearing in the flow line, or sand grains moving faster along the flow line with the same density, or both.

To restate the above in simpler and more general terms, the number of list items represented by each icon may vary: (i) between user interaction sessions; and/or (ii) during a single user interaction session. The numbers of list items represented by a single icon (for example, grain of sand) is sometimes herein referred to as its density. In some embodiments, the density chosen (and re-chosen on a dynamic basis) so that the icons representing a certain list items having a certain status will fit in the appropriate portion of the display of the progress bar.

Some embodiments of the present invention may include one, or more, of the following features, characteristics and/or advantages: (i) provides a whole new methodology of a content-based progress indication and control; (ii) differentiating various status of contents by using differently colored layers; (iii) unconsciously tracking and bookmarking the amount of contents that the user has read; (iv) visualizing the content transfer process and the variant transfer speed; (v) providing consistency of user behaviors and the UI feedback: the direction of the sand flow follows the movement of the user's fingers; (vi) mitigating the content compressing effect when loading new pages of content, which eliminates the confusion of a conventional “jumping scroll bar”; and/or (vii) highlighting newly received contents to alert the user without disturbing the user or taking more window space.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Interest/interaction status (also sometimes more simply referred to as “status”): any scheme for classifying list items into (mutually exclusive, or non-mutually exclusive) groups based on a user's expected, predicted and/or manifested interest and/or the amount and/or type of user interaction with the list item.

What is claimed is:

1. A method comprising:
defining a plurality of interest/interaction statuses;
receiving input data corresponding to a plurality of list items of an ordered list;
classifying, by machine logic, each of the plurality of list items so that each list item of the plurality of list items corresponds to at least one status of the plurality of interest/interaction statuses;
generating, by machine logic, first display data corresponding to a first display including:
a list item display portion displaying, in list order, at least a portion of the list items of the plurality of list items, and
a progress bar display portion displaying a progress bar, with the progress bar providing a visual indication of the relative number of list items correspond to each status of the plurality of interest/interaction statuses.

2. The method of claim 1 further comprising:
displaying, on display device hardware, the first display corresponding to the first display data.

3. The method of claim 1 wherein:
the interest/interaction statuses include the following: new-unviewed, viewed and old unviewed; and
new unviewed status is corresponded to list items of the plurality of list items that meet the following conditions: (i) list item created after start of current user list item interaction session, and (ii) list item not yet displayed on a display device.

4. The method of claim 1 wherein interest/interaction status is based at least in part upon whether the corresponding list item has been displayed and/or displayed for at least a threshold amount of time on a display device.

5. The method of claim 1 wherein interest/interaction status is based at least in part upon whether the corresponding list item was created before or after that start of a current user list item interaction session.

6. The method of claim 1 wherein interest/interaction status is based at least in part upon whether the corresponding list item has been selected by the user such that the full contents of the list item have been displayed to the user.

7. The method of claim 1 wherein interest/interaction status is based at least in part upon whether the corresponding list item has been scrolled through a display of the list items.

8. The method of claim 1 wherein:
the progress bar provides a visual indication of the relative number of list items correspond to each status of the plurality of interest/interaction statuses based, at least in part on color.

9. The method of claim 1 wherein:
the progress bar provides a visual indication of the relative number of list items correspond to each status of the plurality of interest/interaction statuses based, at least in part on use of different icon(s) to represent sets of list item(s).

10. The method of claim 9 wherein the number of list item(s) in a set of list item(s) corresponding to an icon dynamically varies according to the total number of list items in the plurality of list items.

11. The method of claim 1 further comprising:
determining that a first list item, of the plurality of list items, has changed in interest/interaction status;
subsequent to the determination of the change of interest/interaction status of the first list item, generating, by machine logic, second display data corresponding to a second display including:
a list item display portion displaying, in list order, at least a portion of the list items of the plurality of list items, and
a progress bar display portion displaying a progress bar, with the progress bar providing a visual indication of the relative number of list items correspond to each status of the plurality of interest/interaction statuses.

12. The method of claim 11 wherein the change of interest/interaction status of the first list item is a change from old-unviewed status to viewed status.

13. The method of claim 1 further comprising:
subsequent to the generation of the first display data, determining that a first list item has been added to the plurality of list items;
responsive to the determination of the addition of the first list item, classifying the first list item to have an appropriate interest/interaction status;
subsequent to the classification of interest/interaction status of the first list item, generating, by machine logic, second display data corresponding to a second display including:
a list item display portion displaying, in list order, at least a portion of the list items of the plurality of list items, and
a progress bar display portion displaying a progress bar, with the progress bar providing a visual indication of the relative number of list items correspond to each status of the plurality of interest/interaction statuses.

14. The method of claim 11 wherein the classification of interest/interaction status of the first list item is new-viewed status.

15. The method of claim 1 wherein:
sets of list item(s) are represented by icons in the progress bar; and
a location of an icon in the progress bar visually indicates whether the corresponding list item(s) are above, or below, a current location within the display of the plurality of list items.

16. The method of claim 15 wherein:
the progress bar includes a first set of zone(s) and a second set of zone(s);
location of an icon in the first set of zone(s) of the progress bar visually indicates that the corresponding list item(s) are above the current location within the display of the plurality of list items; and
location of an icon in the second set of zone(s) in the progress bar visually indicates that the corresponding list item(s) are below the current location within the display of the plurality of list items.

17. A method comprising:
generating, by machine logic, first display data corresponding to a first display including:
a list item display portion displaying, in list order, at least a portion of list items of an ordered plurality of list items including viewed list items and unviewed list items, and
a progress bar display portion displaying a progress bar, with the progress bar providing a visual indication of the amounts viewed list items and unviewed list items and including a first user interaction portion and a second user interaction portion;
subsequent to generation of the first display data and responsive to a first user gesture on, or in, the first user interaction portion, generating second display corresponding to a second display, including a list item display portion displaying, in list order, only unviewed list items of the ordered plurality of list items; and
subsequent to generation of the second display data and responsive to a second user gesture on, or in, the second user interaction portion, creating third display corresponding to a third display, including a list item display portion including, in list order, list items displayed at a time the first user gesture was made.

18. The method of claim 17 further comprising:
displaying, on display device hardware, the first display corresponding to the first display data;
displaying, on the display device hardware, the second display corresponding to the second display data; and
displaying, on the display device hardware, the third display corresponding to the third display data.

19. The method of claim 17 wherein:
the first user interaction zone of the first display includes a visual representation of a number of unviewed list items created after a start of a current user interaction session; and
the second user interaction zone of the first display includes a visual representation of a number of unviewed list items created before the start of the current user interaction session.

20. A method comprising:
receiving input data corresponding to a plurality of list items of an ordered list;
generating, by machine logic, first display data corresponding to a first display including:
a list item display portion displaying, in list order, at least a portion of the list items of the plurality of list items, and
a progress bar display portion displaying a progress bar, with the progress bar including icons, with each icon representing a set of n list items with n being an integer; and
dynamically determining during a user list item interaction session, by machine logic, a value for n based, at least in part, upon a number of list items that have been loaded to a mobile device including display hardware for displaying the first display.
